(19) United States
(12) Patent Application Publication
(10) Pub. No.: US 2008/0196726 A1
(43) Pub. Date: Aug. 21, 2008

(54) APPARATUS FOR HYPOXIC TRAINING AND THERAPY

(75) Inventors: Roger Leslie Brown, London (GB); David Paul Sumners, Barwick (GB)

Correspondence Address: ANTHONY R. BARKUME, 20 GATEWAY LANE, MANORVILLE, NY, 11949, US

(73) Assignee: SOUTH BANK UNIVERSITY ENTERPRISES LTD, London (GB)

(21) Appl. No.: 12/108,024

(22) Filed: Apr. 23, 2008

Related U.S. Application Data
(63) Continuation-in-part of application No. 10/507,141, filed on May 20, 2005.

(51) Int. Cl. A62B 7/10

(52) U.S. Cl. 128/205.28

(57) ABSTRACT

Breathing equipment to mimic the training of athletes at high altitude comprises a mouthpiece connected to a chamber containing a carbon dioxide absorber which is connected to the atmosphere by a tube. In use the air breathed out passes through the carbon dioxide absorber into the conduit where it mixes with atmospheric air and the mixture re-breathed.

This patent Specification is a Continuation-in-Part of U.S. patent application Ser. No. 10/507,141, which is incorporated herein in its entirety.

### BACKGROUND OF THE INVENTION

The present invention relates to equipment for improving the breathing of people such as athletes, singers, people with breathing difficulties and anyone who wants to improve the efficiency of their breathing and endurance.

Athletes, particularly those who take part in middle and long distance events, often train at high altitudes as such high altitude training is known to improve their performance. This improvement is thought to be due to the lower oxygen levels at high altitudes resulting in the body having to become more efficient in its operations.

An acclimated athlete can run at high altitudes because the body can adapt to hypocapnia. This adaptation permits greatly increased ventilation which supplies enough O₂ not only to prevent hypoxia at rest but also provides enough ventilation for strenuous running. This adaptation brings about improved performance at lower altitudes.

However, this adaptive process does not always go smoothly, and acute mountain sickness is a common occurrence. At high altitudes, the alternating stimulation and inhibition of the respiratory centre, first by hypoxia and then by hypocapnia, leads to Cheyne-Stokes respiration, which can become quite pronounced during sleep. In the apneic phase, severe hypoxia may potentially cause the subject to slip from sleep into coma, and sometimes from coma into death.

A voluntary increase in the rate and depth of breathing causes CO₂ to be exhaled at a faster rate than its rate of production by the body's metabolism and results in a drop in the amount of CO₂ in the blood, i.e., results in hypocapnia. If vigorous, rapid breathing is continued for more than a few minutes, increasingly severe hypocapnia will cause cerebral vasoconstriction and unpleasant nervous system symptoms.

An increased rate and depth of breathing, or hyperpnoea, without an appropriate increase in CO₂ production from metabolism, can be voluntary or caused by a hyperventilation syndrome, anoxic hypoxia, or mechanical ventilation. In all cases, the resultant hypocapnia causes increasingly grave symptoms and is the limiting factor in the amount of excess ventilation that can be achieved. In a number of situations—a good example is the anoxic hypoxia that can occur in high altitude flying—a large increase in ventilation is desirable, and CO₂ enriched air makes this possible.

As well as the respiratory benefits, altitude training leads to increases in oxygen transportation and utilisation advantages such as increased blood volume, increased haemaglobin concentration of blood, increased myoglobin concentration in the muscle, increased capillarisation of the human tissues and increased oxidative metabolism machinery such as oxidative enzymes

### DESCRIPTION OF RELATED ART

Various attempts to utilize exhaled air, which is high in CO₂, have been made as a substitute for providing prepared custom mixes of CO₂ and air. In fact, generations of emergency room physicians have had patients breathe into simple Kraft paper bags to treat hyperventilation that can result from anxiety, fear, or trauma. The paper bag enables a hyperventilating patient to conserve and rebreathe exhaled air.

Variations on the use of paper bags are described in U.S. Pat. Nos. 3,455,294; 4,508,116 and 4,628,926. Long tubes have been substituted for paper bags and these tubes essentially mimic the effect of paper bags.

U.S. Pat. No. 4,275,722 discloses a respiratory exerciser and rebreathing device which, through a system of valves, provides for an inhalation chamber and an exhalation chamber, with a sliding mechanism to vary the amount of air rebreathed from the exhalation chamber. This device has a complex network of chambers, valves and mechanisms, all designed to route exhaled air through an exhalation chamber and through an inhalation chamber that removes moisture from the exhaled air before inhaling. The exhalation chamber is widely open to ambient air so that fresh air is available at the bottom.

These devices all are designed to combat the effects of breathing problems at high altitude and to overcome physiological difficulties and cannot be used to reproduce the effect of high altitude training.

Efforts to reproduce the effect of high altitude training at lower altitudes, in order to avoid the expense of travel to, and living in places of high altitudes by training in rooms or chambers with reduced air pressure are expensive to set up and operate and inconvenient to use. Restricting the airflow to an athlete whilst he or she is training is not effective as the volume of air taken with each breath is reduced, which can cause adverse effects on the athlete. Existing equipment which involves the use of re-breathing air so that the air has a lower oxygen content is not practical as this can lead to excessive carbon dioxide build up as detailed above.

We have now devised a simple effective device for at least partially reproducing the effect of high altitude training which dies not suffer from these disadvantages.

### SUMMARY OF THE PRESENT INVENTION

According to the invention there is provided breathing equipment comprising:

a mouthpiece through which a user can breathe;

a chamber having an inlet and an outlet and containing a carbon dioxide absorber; and

a conduit which is open to the atmosphere;

said mouthpiece being connected to the inlet and said conduit being connected to the outlet of said chamber;

whereby in use the air in said conduit comprises a mixture of air which has been breathed out by the user and air from the atmosphere, which mixture is breathed in by the user.

The carbon dioxide absorber can be any of the conventionally used carbon dioxide absorbers such as caustic soda pellets, soda lime, calcium hydroxide etc.

Preferably the carbon dioxide absorber changes colour as it absorbs carbon dioxide and so it can be seen when it is used up.

The conduit can be a flexible tube and the length of the conduit depends on the amount of air from the atmosphere it is desired to add to the air to be re-breathed, with the longer the conduit the less fresh air form the atmosphere is added on each breath. For tubes of diameter 1.5 cm to 4 cm tubes of lengths of 50 cm to 1.5 metres can be used.

Air from the atmosphere enters the conduit by diffusion and by the reduction in pressure caused by each in-breath (inspiration).

Means eg straps, elasticated bands or a head harness may be provided to attach the mouthpiece to the user's face, or the mouthpiece may comprise a portion for being gripped by the user's teeth and a flange portion for siting in the user's mouth between his lips and his teeth. The mouthpiece may however be constituted by a mask such as a buccal mask.

As there is a reduction in oxygen input in use there is preferably an automatic release mechanism so that, in the event of discomfort wrought by the oxygen content being too low, air can enter directly into mouthpiece. There may accordingly be ducting such as a length of tube between the mouthpiece and the chamber inlet. This ducting may incorporate an oxygen sensor and an associated valve which, if opened permits the ingress of environmental air. Preferably the ducting has a mean diameter of the order of 30 mm.

In use the air is breathed out by the user and passes through the carbon dioxide absorber chamber where excess carbon dioxide is absorbed, and then into the conduit, where it mixes with air from the atmosphere. This air is breathed in through the carbon dioxide absorber chamber and the air breathed will consist of air with an oxygen and carbon dioxide content similar to that found at high altitude.

According to an important feature of the invention the conduit may be arranged to be variable in effective length, thus to vary the carbon dioxide content of the air breathed in. By adjustment of the length of the conduit and the carbon dioxide absorber chamber contents, the conditions at a selected altitude can be reproduced. This enables a graduated acclimatisation to high altitude conditions to be achieved and is equivalent to high altitude training. Moreover such an arrangement readily enables a single embodiment of the equipment to be suitable for use with persons of different breathing capacity; the same piece of equipment might even be used with animals such as horses and dogs.

In one embodiment of this feature of the invention the conduit defines ports along the length thereof, there being an obturator arranged selectively to open any one of the ports. It is preferably the obturator which connects the conduit to atmosphere while the proximal end of the conduit connects with the chamber outlet. Connection of the obturator to the chamber outlet and the then distal end of the conduit to atmosphere is also possible.

The outlet of the conduit to atmosphere preferably incorporates a filter to prevent the ingress of unwanted particles.

Advantageously the conduit is provided in serpentine form with ports at successive nodes. The serpentine form may be constituted in a substantially flat array, which will generally suit a human user more than say a substantially cylindrical array. Insofar as the conduit may have an effective bore of between one and three cm² then a length of the order of one metre is envisaged. In a star shaped array having perhaps eight ports, to avoid the conduit being in a form representing a 30 cm diameter plate the array may be tiered, enabling the plate to be of the order of 15 cm diameter. In the case of a flat or cylindrical array the ports may be in a circle at the inner extent of each loop of the conductor and the obturator can readily consist of a rotary valve. An alternative construction which avoids a large diameter array, if that is desired, is to have a larger number of loops, with some of the inner bends not incorporating a port.

A serpentine conduit may be formed by attaching one to another two or more plate members defining channels, thus forming the conduit. The plates may be formed by injection moulding or vacuum forming for example. The conduit therein may accordingly have an efficient rectangular cross section, perhaps 10-30 mm, square, preferably 16 mm.

Alternatively an array of tubing may be formed. Moreover, by employing two conduit parallel conduit arrays coarse and fine conduit length adjustment may be achieved.

The equipment may further include programmable means for setting the obturator. In this way particular characteristics may be programmed into the equipment and the obturator set accordingly. Rather importantly this feature can even permit obturation to be varied in use, providing intermittent hypoxia, which can benefit training considerably.

Intermittent hypoxia has been shown to increase the plasticity of the nervous system controlling respiration, and may also be applied to the skeletal motor control system to increase potential benefits of strength, power and speed training as well as the endurance benefits.

As well as being used for training athletes, the equipment of the present invention can be used for helping people with weak or defective breathing strengthen their breathing and improve the efficiency of their oxygen metabolism and can be used for overcoming the effects of accidents and disability which result in weakened breathing.

According to a further feature of the invention the equipment may include an oxygen sensor associated with a valve, perhaps sited between the mouthpiece and the chamber and arranged to sense the level of oxygen ahead of the mouthpiece and, if the oxygen level falls dangerously low, to open the valve and allow direct ingress of environmental air or, if need be, oxygen from a supply thereof.

The valve may typically be solenoid driven.

In this context, it will be appreciated that any tubing between the mouthpiece and the conduit inlet should have a volume such that the effective content of conduit will in any normal breath reach the user. When assembling apparatus in accordance with the invention the length of conduit between the chamber and the first opening in the conduit will be selected to provide a median or sweet spot so that the openings in the conduit substantially coincide with the desired full range.

Additionally or instead of means of retaining the mouthpiece to the mouth of a user, the equipment may be associated with a garment such as, in the human context, a waistcoat.

### BRIEF DESCRIPTION OF THE DRAWINGS

Embodiments of the invention will now be described with reference to the accompanying drawings of which:

FIG. 1 is a schematic sketch of a simple embodiment of the invention;

FIGS. 2 and 3 illustrate an embodiment employing a serpentine conduit; and

FIGS. 4 and 5 illustrate an embodiment mounted on a waistcoat;

FIG. 6 is a variant of the embodiment illustrated in FIG. 2, having a buccal mask;

FIG. 7 is a variant of the embodiment illustrated in FIGS. 4 and 5, having a buccal mask;

FIG. 8 illustrates strap adjustment; and

FIG. 9 is a schematic diagram of apparatus shown in FIG. 6.

### DETAILED DESCRIPTION

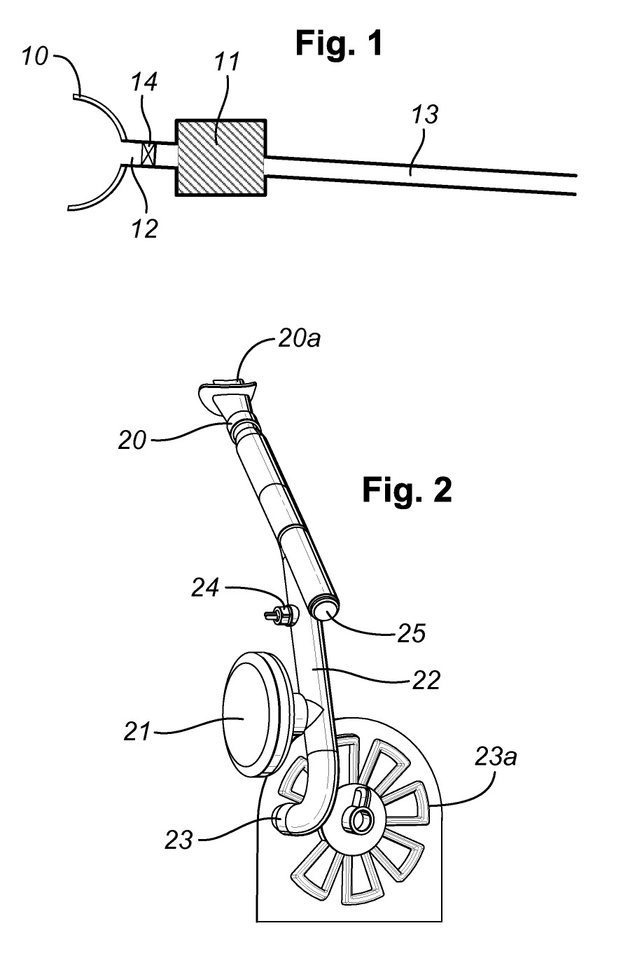

The simple embodiment shown in FIG. 1 comprises a mouthpiece 10, a chamber 11 containing soda lime and having an inlet and an outlet, a duct 12 connected between the mouthpiece 10 and the chamber 11 inlet and a conduit 13 connected at its proximal end to the outlet of the chamber 11. At its distal end the conduit 13 is open to the atmosphere. In the duct 12 is fitted a release valve 14 which can be actuated to open an air inlet directly into the mouthpiece in case of discomfort or danger.

In use, a user straps the mouthpiece 10 over his face so that the user breathes in and out therethrough. When a user breathes out the air breathed out by the user (the exhalate) passes through the carbon dioxide absorber chamber 11, where excess carbon dioxide is absorbed, and then into the conduit 13, where it mixes with air from the atmosphere. This air is then breathed in through the carbon dioxide absorber chamber 13 and the air breathed in will consist of air with an oxygen and carbon dioxide content similar to that found at high altitude.

By adjustment of the length of the conduit 13 and the carbon dioxide absorber chamber 11 contents, the conditions at a selected altitude can be reproduced. This enables a graduated acclimatisation to high altitude conditions to be achieved and is equivalent to high altitude training.

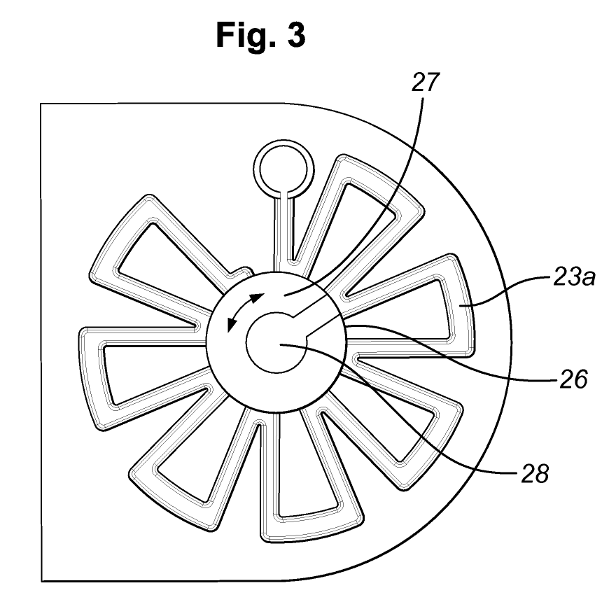

The embodiment illustrated in FIGS. 2 and 3 has a mouthpiece 20, a chamber 21 having an inlet and an outlet, a duct 22 connected between the mouthpiece 20 and the chamber 21 and a conduit 23 connected between the chamber 21 and atmosphere. In the duct 22 is fitted a sensor 24 and an associated inlet valve 25.

The mouthpiece 20 comprises a portion 20a for being gripped between the user's teeth and a flanged portion for siting between the user's teeth and his lips.

The conduit 23 has a serpentine form in circular planar array 23a. At the inner bends, between each loop thereof, are openings 26 adjacent a rotary valve 27. The valve 27 is constructed with a single entry connected via a central vent 28 to atmosphere. Thus the valve 27 may be rotated to any one of the openings 26 and, if desired to close the apparatus off, to none. In this manner the length of the conduit 23 open to atmosphere is variable. The valve 27 contains a filter 28.

The chamber 21 is openable to permit loading therein of a carbon dioxide removal agent, in this case calcium hydroxide.

The sensor 24 is arranged for the sensing of oxygen in the duct 22 so that should the oxygen level fall below a safe level an electrical circuit linking the sensor 24 with the valve 25 will be broken and the valve 25 will open, allowing atmospheric air into the duct 22. Otherwise, when the oxygen level in the duct 22 is adequate, the valve 25 is closed. This arrangement of a valve venting the duct 22 is particularly effective with a duct having a mean bore of the order of 3 cm.

In a particular example of this embodiment of the invention the total length of the conduit 23 is of the order of one metre and there are eight loops in the array, thus having a length each of 125 mm. The array is formed by injection forming in two parts thereof a plastics material and then joining the parts. In this way the conduit in the array can have a substantially square cross section of the order of 16 mm×16 mm.

In use, a user holds the mouthpiece 20 between his lips in order to breathe in and out therethrough. When a user breathes out the air breathed out by the user (the exhalate) passes through the carbon dioxide absorber chamber 21, where excess carbon dioxide is absorbed, and then into the conduit 23, where it mixes with air from the atmosphere. This air is then breathed in through the carbon dioxide absorber chamber 23 and the air breathed in will consist of air with an oxygen and carbon dioxide content similar to that found at high altitude.

Variation of the altitude level is effected by adjusting the position of the rotary valve 27, which varies the effective length of the conduit 23.

In another example of this embodiment of the invention a programmable control is associated with the valve 27 enabling automatic intermittent hypoxia to be achieved or, if desired, a cycle of varying levels of hypoxia.

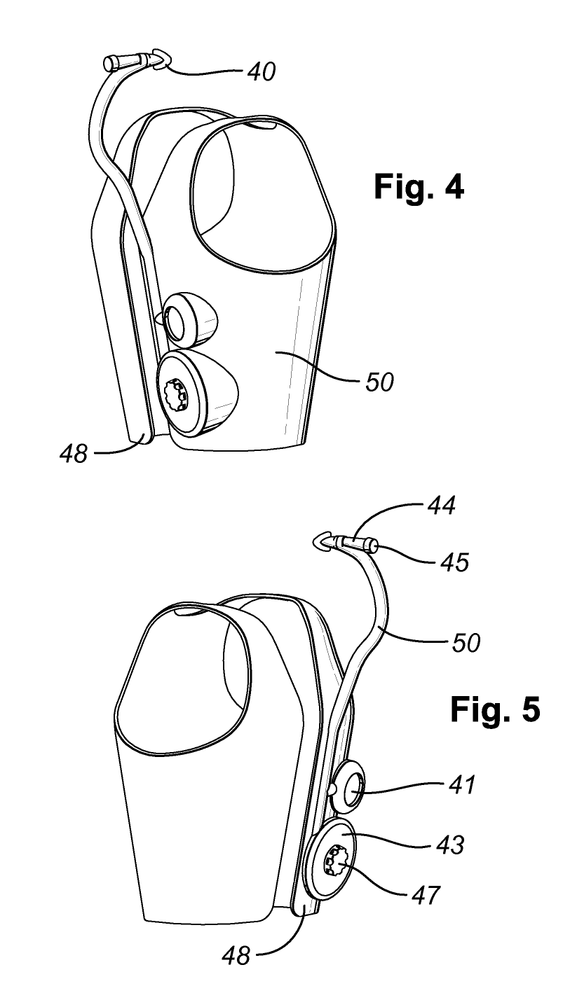

In the embodiment illustrated in FIGS. 4 and 5 a carbon dioxide absorption chamber 41 and a flat conduit 43 array are fitted to a waistcoat 50. A tube 42 is connected between the chamber 41 and a mouthpiece 40. There is an oxygen sensor 44 with associated solenoid valve 45 in the tube 42 close to the mouthpiece 40.

The conduit array 43 has a manually adjustable rotary valve 47 controlling the effective length of the array.

The waistcoat is closable by touch and close fastener strips (VELCRO™)

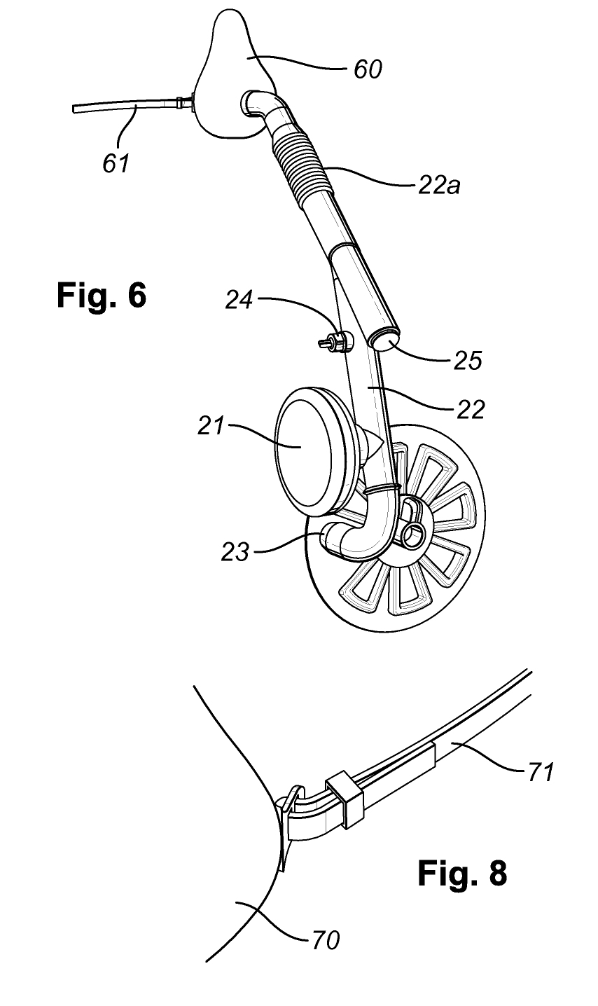

The embodiment illustrated in FIG. 6 is substantially similar to that described with reference to FIGS. 2 and 3 except that the mouthpiece comprises a buccal mask 60 having adjustable elasticated straps 61 for passing around the user's head. The duct 22 is also shown as flexible at 22a.

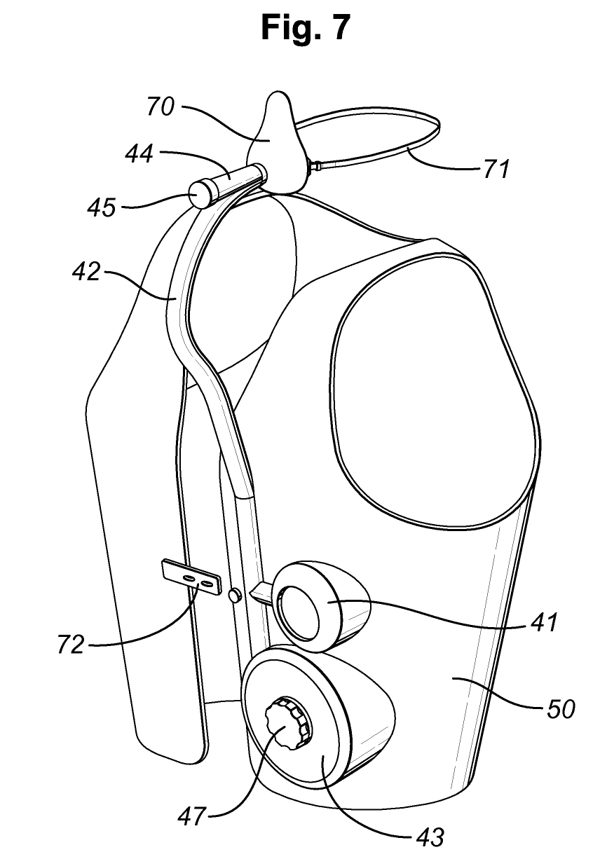

The embodiment illustrated in FIG. 7 is substantially similar to that described with reference to FIGS. 4 and 5, except that the mouthpiece comprises a buccal mask 70 having adjustable elasticated straps 71 for passing around the user's head. The waistcoat is shown as being closable with a tag, buttonhole and button system

FIG. 8 illustrates the adjustment of the straps 61, 71.

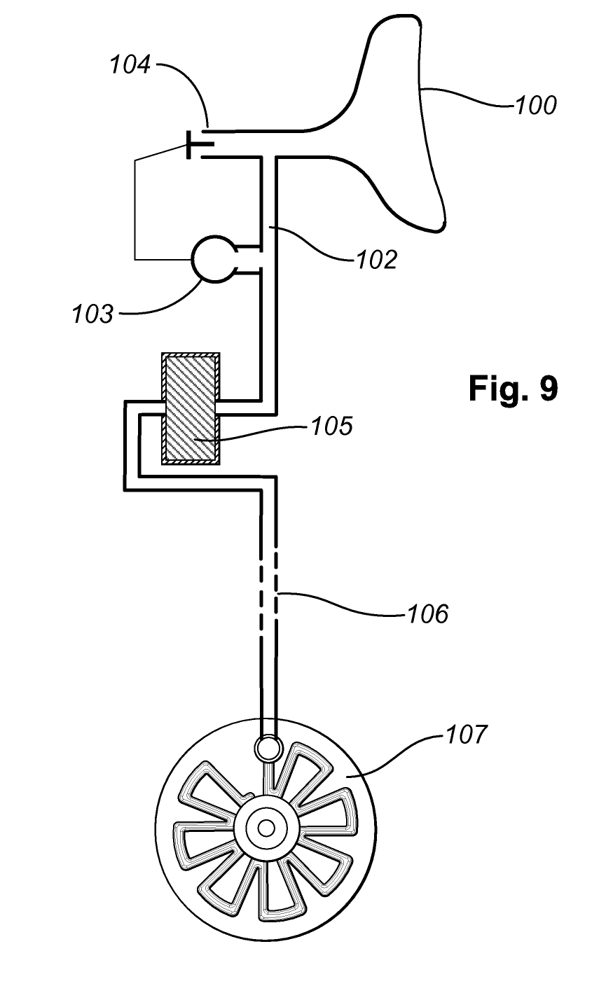

FIG. 9 demonstrates the flow path of respiratory air in the apparatus, which comprises a buccal mask 100, a supply tube 102 having an oxygen sensor 103 and an associated override inlet valve 104, a filter 105, and a conduit having an adjustable fixed length portion 106 and a variable length portion 107 leading to outlet 108.

The length of the portion 106 of the conduit is adjusted for a particular user so that a desired range of oxygen levels can be achieved via the variable length portion. The adjustment of the length of the portion 106 may be arranged to be permanently effected or to be re-adjustable, for example by a telescope or concertina device.

Soda lime carbon dioxide absorbers for charging into the chamber 11, 21 are commercially available and typically can last for 3-4 hours of continuing use. This however depends upon the user's breathing rate which can vary between 0.2 litres per minute at rest to 3.0 litres per minute in extremely heavy work conditions.

One such commercially available Soda Lime carbon dioxide absorber is Sofnolime™ sold by Airgas Puritan Medical. A pre-filled soda lime container is also available in a 1 kg drum translucent so that colour change is visible.

By exchanging the mouthpiece for a muzzle harness the apparatus is made suitable for providing altitude training for horses and dogs in particular among the animals used in sports.

1. Breathing equipment comprising:
a mouthpiece through which a user can breathe in and out;
a chamber having an inlet and an outlet and containing a carbon dioxide absorber; a conduit which is open to the atmosphere;
said mouthpiece being connected to the inlet and said conduit being connected to the outlet of said chamber;
whereby in use the air in said conduit comprises a mixture of air which has been breathed out by the user and air from the atmosphere, which mixture is breathed in by the user through the chamber.

2. Breathing equipment as claimed in claim 1 and wherein said carbon dioxide absorber comprises at least one of caustic soda pellets, calcium hydroxide and soda lime.

3. Breathing equipment as claimed in claim 1 and wherein there are attachment means to attach said mouthpiece to the face of a user.

4. Breathing equipment as claimed in claim 3 and wherein said attachment means are elasticated straps.

5. Breathing equipment as claimed in claim 1 and wherein said conduit has a mean diameter of 1.5 cm to 4 cm and a length of 50 cm to 1.5 metres.

6. Breathing equipment as claimed in claim 1 and having valve means operable upon sensing air containing oxygen below a predetermined level to enable air to enter directly into mouthpiece.

7. Breathing equipment as claimed in claim 1 and wherein said conduit is arranged to be variable in effective length, thus to vary the carbon dioxide content of the air breathed in.

8. Breathing equipment as claimed in claim 1 and wherein said carbon dioxide absorber is arranged to change colour as it absorbs carbon dioxide.

9. Breathing equipment as claimed in claim 1 and wherein a head harness is provided to attach said mouthpiece to the user's face

10. Breathing equipment as claimed in claim 1 and wherein said mouthpiece comprises a portion for being gripped by the user's teeth and a flange portion for siting in the user's mouth between his lips and his teeth.

11. Breathing equipment as claimed in claim 1 and wherein said mouthpiece is constituted by a mask such as a buccal mask.

12. Breathing equipment as claimed in claim 7 and wherein said conduit defines ports along the length thereof, there being an obturator arranged selectively to open any one of the ports.

13. Breathing equipment as claimed in claim 12 and wherein said obturator connects said conduit to atmosphere while the proximal end of said conduit connects with the chamber outlet.

14. Breathing equipment as claimed in claim 1 and wherein the outlet of said conduit to atmosphere incorporates a filter to reduce the ingress of unwanted particles.

15. Breathing equipment as claimed in claim 1 and wherein said conduit is provided in serpentine form.

16. Breathing equipment as claimed in claim 15 and wherein said serpentine form is constituted in a substantially flat array.

17. Breathing equipment as claimed in claim 15 and wherein said serpentine form is constituted in a substantially cylindrical array.

18. Breathing equipment as claimed in claim 16 and wherein said substantially flat array is star shaped.

19. Breathing equipment as claimed in claim 12 and having eight ports.

20. Breathing equipment as claimed in claim 15 and wherein said array is tiered.

21. Breathing equipment as claimed in claim 12 and wherein the ports are in a circle at the inner extent of a loop of said conduit and said obturator consists of a rotary valve.

22. Breathing equipment as claimed in claim 16 and wherein said conduit is formed by attaching one to another two or more plate members defining channels.

23. Breathing equipment as claimed in claim 22 and wherein said plates are formed by injection moulding.

24. Breathing equipment as claimed in claim 22 and wherein said plates are formed by or vacuum forming.

25. Breathing equipment as claimed in claim 1 and wherein said conduit has a rectangular cross section 10-30 mm square.

26. Breathing equipment as claimed in claim 15 and wherein said serpentine array is provided in an array of tubing.

27. Breathing equipment as claimed in claim 1 and having parallel conduit arrays arranged to provide coarse and fine conduit length adjustment.

28. Breathing equipment as claimed in claim 12 and having programmable means for setting said obturator.

29. Breathing equipment as claimed in claim 28 and wherein said programmable means is arranged to vary obturation in use, providing intermittent hypoxia.

30. Breathing equipment as claimed in claim 6 and wherein said valve is solenoid driven.

31. Breathing equipment as claimed in claim 1 and having a duct connecting said mouthpiece with the inlet of said chamber.

32. Breathing equipment as claimed in claim 31 and wherein said duct has a bore of mean diameter of the order of 30 mm.

33. A method for breathing training and wherein breathed out by the user passes through a carbon dioxide absorber in a chamber where excess carbon dioxide is absorbed, and then into a conduit open to the atmosphere, in which conduit the air breathed out is mixed with air from the atmosphere, this air mixture is then breathed in through the carbon dioxide absorber and, by varying the length of the conduit, the oxygen content of the air breathed in is varied.

34. A method as claimed in claim 33 and wherein the length of the conduit and the content of the carbon dioxide absorber in the chamber are adjusted so that the air breathed in consists of air with an oxygen and carbon dioxide content similar to that found at a high altitude.

35. A method as claimed in claim 33 and wherein upon sensing air containing oxygen below a predetermined level a valve is opened to enable air to enter directly into mouthpiece.

36. A method as claimed in claim 33 and wherein the length of the conduit is controlled by an obturator and programmable means for setting said obturator.
